(19) United States
(12) Patent Application Publication
(10) Pub. No.: US 2024/0259834 A1
(43) Pub. Date: Aug. 1, 2024

(54) METHOD, APPARATUS, AND SYSTEM FOR HIGH FREQUENCY BEAM ACQUISITION

(71) Applicant: Huawei Technologies Co., Ltd., Shenzhen (CN)

(72) Inventors: Ahmad Abu Al Haija, Ottawa (CA); Mohammadhadi Baligh, Ottawa (CA)

(21) Appl. No.: 18/630,375

(22) Filed: Apr. 9, 2024

Related U.S. Application Data
(63) Continuation of application No. PCT/CN2021/123618, filed on Oct. 13, 2021.

(51) Int. Cl. H04W 16/28; H04L 5/00; H04W 8/00; H04W 64/00

(52) U.S. Cl. CPC H04W 16/28; H04L 5/0051; H04W 8/005; H04W 64/00

(57) ABSTRACT

Aspects of the present disclosure disclose methods for communication. Coarse location of the receiver can be determined via several methods including, but not limited to, positioning sensing to determine a location of the receiver and out-of-band reference signal measurements.

### CROSS-REFERENCE TO RELATED APPLICATIONS

The application is a continuation of International Application No. PCT/CN2021/123618, filed on Oct. 13, 2021, the disclosure of which is hereby incorporated by reference in its entirety.

### TECHNICAL FIELD

The present disclosure relates generally to wireless communications, and in particular embodiments, to methods and devices for high frequency beam acquisition.

### BACKGROUND

In some wireless communication systems, user equipments (UEs) wirelessly communicate with a base station (BS) to send data to the base station and/or receive data from the base station. A wireless communication from a UE to a BS is referred to as an uplink (UL) communication. A wireless communication from a base station to a UE is referred to as a downlink (DL) communication.

Resources are required to perform uplink and downlink communications in such wireless communication systems. For example, a BS may wirelessly transmit data, such as a transport block (TB), using wireless signals and/or physical layer channels, to a UE in a downlink transmission at a particular frequency and over a particular duration of time. The frequency and time duration used are examples of resources.

In some wireless communication systems, beamforming is used in which a communication signal is transmitted in a particular direction instead of being transmitted omni-directionally. This beam-based approach for signal transmission may allow signal power to be focused in a particular direction with higher possibility of being detected at the destination. In some situations, a transmitter in a communication cell is able to transmit in many directions, but by using multiple separate beams. Therefore, as a receiver moves in relation the transmitter, the transmitter may use different beams to stay in contact with the receiver. As a receiver moves between beams of the transmitter in the cell or away from a transmitter and towards a neighboring transmitter in an adjacent cell, a change in signal strength perceived by the receiver, which may be considered to be an event, can result in a change from one beam to another of the transmitter or handover from the transmitter to the neighboring transmitter a Tracking of cell-based events may result in poor performance in beam-based deployments particularly with regard to latency issues.

High frequency communication, one example of which is subTHz communication, is a technology that may improve the performance of future cellular networks due to a large bandwidth for communication. However, the higher the frequency involved the smaller the antenna sizes involved. Therefore, more antennas may be needed in multiple-input multiple-output (MIMO) systems to facilitate the high frequency communication (e.g. by satisfying a certain signal to noise ratio (SNR) threshold at the receiver).

Beam acquisition may become challenging due to a large searching space (i.e. a large number of possible directions where a receiver could be located) for narrow beams that may result in a longer duration of time to acquire a preferred beam to be used for communication between a transmitter and receiver. Moreover, even if wide beams are used to search for the receiver and a search is performed using narrow beams within a range of a wide beam determined to encompass the receiver, the wide beams may be insufficient to deliver a signal with sufficient quality to be measured at the receiver.

### SUMMARY

Beams that are used for communication at higher frequencies may be narrow to focus the signal power on specific direction. Hence, a narrow beam at high frequency can be defined as a beam with a width that is sufficient to facilitate high frequency communication given the channel conditions like: path-loss, the distance and environment between the transmitter and the receiver. With narrow beams, the beam management and beam acquisition becomes more complicated. Note that at different frequency ranges, the beam widths (that facilitate the communication) are different due to different path-loss and antenna sizes, i.e., a narrow beam at low frequency is wide compared to that at high frequency.

Aspects of the present disclosure may enable faster beam acquisition for a transmitter, such as a base station (BS) and a receiver that is a target of acquisition (a target user equipment (UE)) in multiple input multiple output (MIMO) systems at subTHz frequencies based on reduced overhead for determining a location of the receiver by using information about objects, such as nearby UEs, and/or obstacles in proximity to the receiver. Information pertaining to the location of the receiver may be used to determine a beam (or beam pairs) between a transmitter and the receiver. The location information may be used to determine a beam to facilitate the high frequency communication with the receiver (e.g. by satisfying a SNR threshold at the receiver). The location of the receiver may have a specific accuracy or precision that enables a beam narrow to be used to facilitate the high frequency communication. When the location of the receiver is known with higher accuracy or precision beam acquisition for the high frequency communication may be more efficient as less control signaling is used in the acquisition process. The accuracy or precision of the location of the receiver may be known at different scales, such as to with centimeters, decimeters, or meters of the actual location. The location may be considered a coarse location. The term “coarse location” is used to indicate a specific rough approximation of where the receiver is located. Information that aids in identifying the coarse location of the receiver or identifies the coarse location of the receiver is considered to be coarse location information. Examples of coarse location information that may aid in identifying the coarse location of the receiver include one or more of: information about an environment in proximity to the receiver including a position of at least one object; an identification of nearby UEs with fixed or quasi-fixed locations; information gathered from device-to-device (D2D) discovery occurring during beam-sweeping between the receiver and nearby UEs with fixed or quasi-fixed locations using either wide beam or narrow beam reference signals; or beam-sweeping between the transmitter and the receiver with wide beam low frequency reference signals. Coarse location of the receiver can be determined via several methods including, but not limited to, positioning sensing to determine a location of the receiver and out-of-band reference signal measurements. While obtaining accurate location information using high accuracy positioning techniques may help acquire a narrow beam quickly between the transmitter and receiver, processing time for determining the receiver position increases as the accuracy increases. Hence, aspects of the present location aim to reduce overhead used to acquire a narrow beam between the transmitter and receiver by using coarse location information of the receiver.

Aspects of the present disclosure may enable low overhead as part of beam acquisition between the BS and the target UE when low resolution map type information is used, and as a result feedback information about a coarse location of the target UE may be reduced. For example, information may include identifying a particular pixel address that corresponds to an object or the target UE in a low resolution map type image that corresponds to an area local to the target UE or a larger area served by the BS that includes the target UE.

According to an aspect, there is provided a method for beam acquisition at high frequency between a user equipment (UE) and a base station (BS). The method includes determining location information regarding a location of the UE and performing beam-sweeping for the beam acquisition between the UE and the BS using one or more reference signals in a beam determined in accordance with the location information.

In some embodiments, determining location information regarding the location of the UE comprises determining the location information using one or more of: information about an environment in proximity to the UE comprising a position of at least one object; an identification of nearby UEs with fixed or quasi-fixed locations; device-to-device (D2D) discovery comprising beam-sweeping between the UE and nearby UEs with fixed or quasi-fixed locations with wide beam or narrow beam reference signals; or beam-sweeping between the BS and the UE with wide beam low frequency reference signals.

In some embodiments, the D2D discovery between the UE and nearby UEs with fixed or quasi-fixed locations includes selecting, by the UE, one or more nearby UE with which to perform D2D discovery; or receiving, by the UE, an identification of one or more nearby UE with which to perform D2D discovery.

In some embodiments, the performing the beam-sweeping between the UE and the BS includes: receiving, by the UE, the one or more reference signal that have been sent in a direction based on the location information regarding the location of the UE; measuring, by the UE, the one or more reference signal; and transmitting, by the UE, first feedback information resulting from measurement of the one or more reference signal.

In some embodiments, the location information regarding the location of the UE further comprises one or more of: a size of an area local to the UE; an identification of locations of the one or more nearby UE and an identifier for each of the one or more nearby UE; an identification of a location of an object in an area local to the UE; an identification of a location of an object to be used as a reference marker in an area local to the UE; and an identification of locations of boundaries of sub-areas in an area local to the UE.

In some embodiments beam-sweeping between the BS and the UE with wide beam low frequency reference signals involves: receiving, by the UE, one or more wide beam out-of-band reference signal; measuring, by the UE, the one or more wide beam out-of-band reference signal; and transmitting, by the UE, an identification of a wide beam out-of-band reference signal determined to have a measured signal strength equal to or larger than a predefined threshold.

In some embodiments, the performing the beam-sweeping between the UE and the BS comprises: transmitting, by the BS, the one or more reference signal in a direction based on the location information regarding the location of the UE; and receiving, by the BS, first feedback information resulting from measurement of the one or more reference signal; and determining one or more angle of departure (AoD) at the BS and one or more angle of arrival (AoA) at the UE based on the feedback information.

In some embodiments, the method further includes receiving, by the BS, second feedback information from the UE resulting from the D2D discovery between the UE and one or more UE in the area local to the UE, the second feedback information comprising the location information or information that enables the location information to be determined.

In some embodiments, the beam-sweeping between the BS and the UE with wide beam low frequency reference signals includes: transmitting, by the BS, one or more wide beam out-of-band reference signal; receiving, by the BS, third feedback information from the UE resulting from measurement of the one or more wide beam out-of-band reference signal received at a UE; and transmitting, by the BS, coarse location information regarding features in an area local to the UE.

In some embodiments, transmitting location information regarding features in an area local to the UE includes transmitting, by the BS, a bitmap to the UE comprising the one or more nearby UE and/or objects.

In some embodiments, the location information further comprises one or more of: a size of the area local to the UE for which the location is being provided; an identification of locations of the one or more nearby UE and an identifier for each of the one or more nearby UE; an identification of a location of an object in the area local to the UE; an identification of a location of an object to be used as a reference marker in the area local to the UE; and an identification of locations of boundaries of sub-areas in the area local to the UE in which the UE may be located.

According to an aspect, there is provided a device that includes a processor and a computer-readable medium having stored thereon processor executable instructions that when executed cause the device to determine location information regarding a location of the UE and perform beam-sweeping for the beam acquisition between the UE and the BS using one or more reference signals in a beam determined in accordance with the location information.

The device may be a transmitter, such as a base station, or a receiver, such as a user equipment (UE).

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the disclosure may occur.

FIG. 1B is another schematic diagram of a communication system in which embodiments of the disclosure may occur.

FIG. 2 is a block diagram illustrating example electronic devices and network devices.

FIG. 3 is a block diagram illustrating units or modules in a device in which embodiments of the disclosure may occur.

FIG. 4 are four examples of how a coarse location of a UE may be determined as part of a UE acquisition according to aspects of the present disclosure.

FIG. 5 is an example of how a coarse location of a UE may be determined as part of a UE acquisition according to an aspect of the present disclosure.

FIG. 6 is an example graphical plot showing the relationship between beam-width for device to device (D2D) discovery and beam sweeping overhead and location accuracy when determining the UE location.

FIG. 7 is an example of how a coarse location of a UE may be determined as part of a UE acquisition according to an aspect of the present disclosure.

FIG. 8A is a representation of beam direction and beam-width size for a UE that is used for D2D discovery when the beam-width size is 45 degrees.

FIG. 8B is a representation of possible subset areas within a coarse location area, each subset area being an area in which a UE could be located based on feedback information received from two nearby UEs as a part of D2D discovery according to an aspect of the present disclosure.

FIG. 9 is a flow diagram illustrating an example of signaling that occurs between a base station, a UE that is being acquired by the BS, and a fixed position UE that performs D2D discovery with the UE that is being acquired by the BS according to an aspect of the present disclosure.

FIG. 10 is an example showing how a wide angle beam may encompass multiple subset areas that include devices that could be used as part of beam acquisition of a UE according to an aspect of the present disclosure.

FIG. 11 illustrates how the subset areas shown in FIG. 10 can be used to create images that can be used by the BS or UE as part of the acquisition of a UE according to an aspect of the present disclosure.

FIG. 12 illustrates how the additional objects or obstacles can be added to an image of a subset area being used by the BS or UE as part of the acquisition of a UE according to an aspect of the present disclosure.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Beam acquisition for massive MIMO systems can be challenging at high frequencies such as subTHz band (>100 GHz) due to the large overhead of control signaling and processing time needed when performing beam sweeping (beam seeping overhead) via narrow beams and potentially due to weak signals that may be received via wide beams.

When performing beam sweeping via narrow beams, the transmitter sends reference signals via narrow beams in different directions while the receiver searches via narrow beams for reference signals transmitted by the transmitter, also in a number of different directions. Examples of a type of reference signal that may be transmitted by a transmitter, such as a base station, may be a channel state information reference signal (CSI-RS) or a positioning RS (PRS). An example of a type of reference signal that may be transmitted by a receiver, such as a user equipment, may be a sounding reference signal (SRS). If only narrow beams are being used, then many beams may be needed, as opposed to when wide beams are used, fewer beams may be needed. Beam sweeping overhead involves a number of beam pairs (a transmitter beam and a receiver beam forming a beam pair) that are searched in order to find one or more beam pairs that have preferred characteristics (e.g., best signal strength) for data communication between the transmitter and receiver. Besides the number of beam pairs, the beam sweeping overhead also depends on a duration to perform the measurement (e.g. measurement of the receive signal strength). The time to perform the measurement may also depend on the sequence length. The variation in sequence length determines quality of the measurement. For example a longer sequence length results in high quality and shorter length results in lower quality. However, a longer sequence length results in higher overhead. Therefore, there is a tradeoff between measurement quality and the amount of overhead. Note that with fixed duration per measurement of one beam-pair, the beam sweeping overhead is reduced when searching among fewer beam-pairs to find one or more beam pairs that have preferred characteristics (e.g., best signal strength).

Hierarchical beam searching involves using wide-beam beam sweeping first to acquire and/or select one or more wide beams that provide a coarse direction and then using narrow-beam beam sweeping within with the selected one or more wide beams to acquire the narrow beams. When wide beam signals are too weak, hierarchal beam-sweeping may not be suitable for beam acquisition at high frequency frequencies (i.e. subTHz frequencies).

Aspects of the present disclosure may facilitate beam acquisition by reducing the searching space for the narrow-beam reference signals with the help of additional information about. In some embodiments, the beam acquisition may be faster, if the beam sweeping overhead is reduced.

The present disclosure also provides examples of methods of signaling between the transmitter, receiver, other devices that the receiver may communicate with, and objects and/or obstacles to obtain information to further determine the coarse location of the receiver.

In some embodiments of the present disclosure, beam acquisition may be performed by determining a coarse location of a receiver. Determining a coarse location of a receiver may include using one or more of the following types of information:
information based on relative angles between a receiver and nearby UEs or objects in proximity to the receiver that have been determined via sensing or map knowledge provided to the receiver or determined by the receiver;
information based on positioning information, such as Global Positioning Satellite (GPS) information;
information based on out-of-band measurement, e.g., low frequency reference signal measurements; or
information based on maps and images of the communication environment.

The various types of information described above may be known to the transmitter, or network that the transmitter is part of, or determined by the transmitter or network, or determined by the receiver and communicated to the transmitter or network.

Once the coarse location of the receiver is determined based on the various types of information described above but possibly not enough to acquire a narrow beam that is desired for high frequency communication, narrow-beam beam sweeping between the transmitter and receiver in directions corresponding to the coarse location determined in the first step can be performed for acquisition.

The method described above may jointly be utilized to reduce the total beam sweeping overhead used for beam acquisition. Total beam sweeping overhead includes the beam sweeping overhead between the transmitter and the receiver, that may include wide-beam beam sweeping to aid in determining a coarse location and narrow-beam beam sweeping used when the coarse location has been determined, and the beam sweeping overhead between the receiver and nearby UEs that may be used to further determine the coarse location of the receiver.

The method described above may use locations of nearby UEs, known locations of nearby obstacles, measurements using out-of-band frequencies, such as low frequency signals (e.g., sent via wide beams) and/or maps or images of the communication environment.

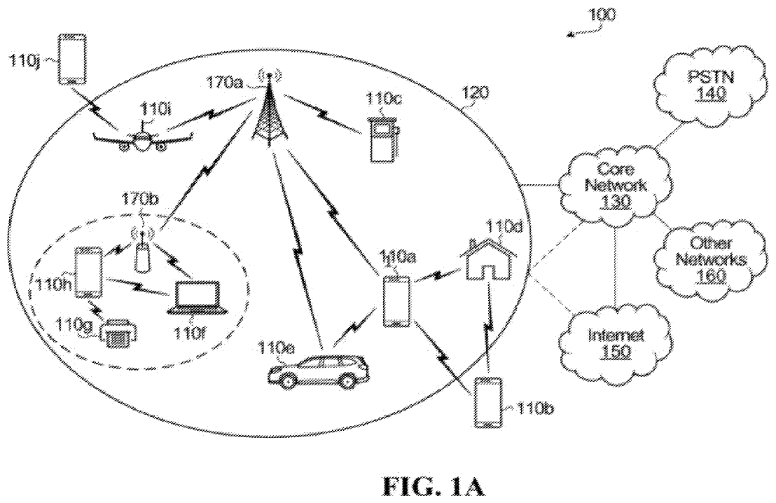

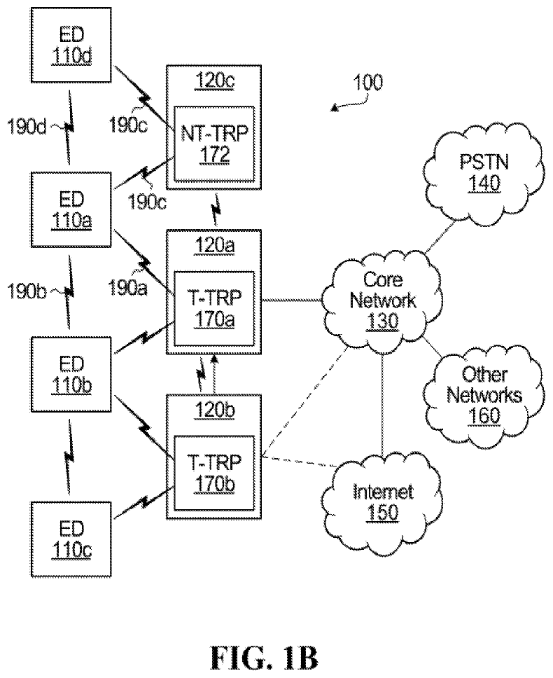

FIGS. 1A, 1B, and 2 provide context for the network and devices of a wireless communication system that may implement aspects of the inter-cell mobility management methods of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example wireless communication system 100 (hereinafter referred to as system 100) which includes a network in which embodiments of the inter-cell mobility management methods of present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

The communication system 100 may provide a wide range of communication services and applications (such as earth monitoring, remote sensing, passive sensing and positioning, navigation and tracking, autonomous delivery, and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such technologies.

The EDs 110a-110c communicate with one another over one or more SL air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the T-TRPs 170a-170b or NT-TRPs 172, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 11o may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

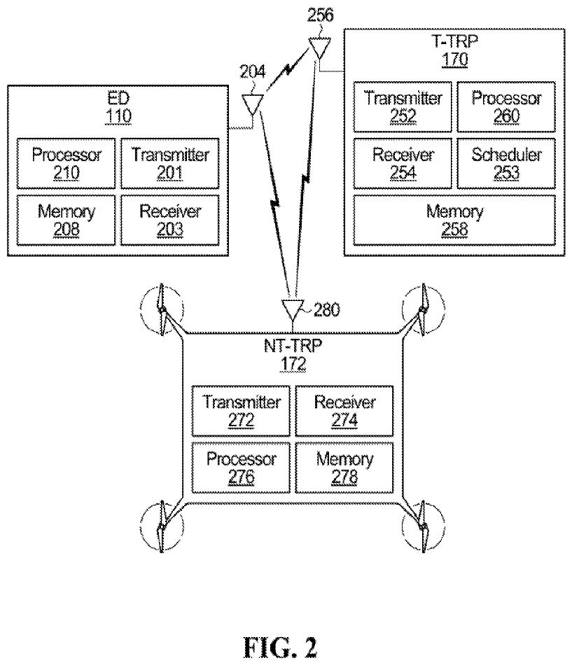

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 11o, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprises several framework, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

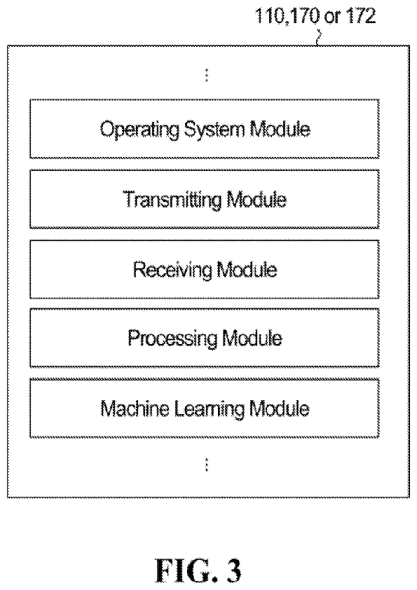

FIG. 4 illustrates in further detail four examples of how beam sweeping overhead may be reduced and potentially speed up the beam acquisition process by reducing ambiguity about receiver location or direction.

FIG. 4 shows four different examples 440, 450, 460, 470 to aid in determining the coarse location of a receiver. In the case of FIG. 4, the receiver is a target UE 410 and the transmitter is an Access Point (AP). While the transmitter is indicated to be an AP in FIG. 4, the transmitter in these example, and more generally in other embodiments to the disclosure, could be any type of base station device. Each of the four examples depict a rectangular boundary 405, the boundary 405 having two vertical sides and two horizontal sides that may represent, for example, a room 400. The AP 420 is indicated to be located along the bottom horizontal side. There are eight other UEs 430a-430h in the room 400 in addition to UE 410. There is also a door 435 in a corner of the room located along the top horizontal side.

In the first example 440, one or more wide beams can be used to find a coarse location of the target UE 410. For example, the AP 420 can broadcast multiple wide beam reference signals in different directions. Each wide-beam reference signal may have an index that can be used to identify the wide-beam reference signal and as a result a direction of the coarse location of the target UE 410. The target UE 410 can then provide feedback to the AP 420 to indicate which wide beam reference signal (or reference signals) has a strong signal (e.g. has achieved a certain threshold, or has a strongest signal), indicating a direction of the target UE 410. In the first example 440, a wide beam 442 is shown that has been identified as encompassing the location of the target UE 410. Further details will be provided below regarding the signaling that occurs between the AP 420 and the target UE 410 in order to use a wide beam to determine the coarse location of the target UE 410.

The rectangular boundary 405, target UE 410, AP 420, UEs 430a-430h, wide beam 442 and door 435 have the same orientation in examples 450, 460 and 470. While the boundary in the examples of FIG. 4 are a rectangular shape, it should be understood that an area may have any boundary shape, and FIG. 4 shows merely one example.

In the second example 450, one or more fixed, or quasi-fixed, UE in proximity to the target UE can be used to potentially reduce the size of the coarse location of the target UE 410. Quasi-fixed in this sense means that the UEs are nodes that “rarely” move or generally stay in one location for a long time. For example, a person may have a laptop in an office and work on it at that location for 3 hours. Then, the person may move his laptop to a meeting room for another two hours. Hence, the laptop here can be considered as a node with quasi-fixed location. In the second example 450, within the range of the wide beam 442 identified to encompass the target UE 410, two UEs 430e and 430 f are fixed or quasi-fixed UEs in proximity to target UE 410. UE 430d, which is within the wide beam 442, is not identified as a fixed position UE and is therefore not used as part of this process. The AP 420 may be determined that UEs 430e and 430f are fixed or quasi-fixed UEs based on monitoring over time and the UEs not having moved. As these two UEs 430e and 430f have a fixed or quasi-fixed location their location is known to be substantially stationary as a reference point and can be helpful in further defining the coarse location of the target UE 410. Because UEs 430e and 430f are fixed or quasi-fixed UEs, the target UE 420 can determine the target UE 410 position with respect to UEs 430e and 430f. In addition to fixed or quasi-fixed UEs, other substantially stationary objects in proximity to the target UE 410 may be useful in determining the coarse location of the target UE 410. For example, other objects may include the door 435, a pillar (not shown), a window (not shown) or other structural features, the location of which may be obtained via one or more sensing methods. Examples of sensing methods that can be used for positioning include, but are not limited to: fingerprinting techniques (via WiFi measurements), vision based positioning (for object recognition), time-delay measurements, global positioning systems, visible light positioning, and internet protocol (IP) based geolocation.

In the third example 460, one or more fixed, or quasi-fixed, UE in proximity to the target UE can be used to potentially reduce the size of the coarse location of the target UE 410, by determining relative angles between the target UE 410 and fixed UEs determined to be in proximity to the target UE 410. For example, within the range of a wide beam 442, two UEs 430e and 430f are indicated to be fixed, or quasi-fixed, UEs in proximity to the target UE 410. It may be possible to also determine the coarse location of the target UE 410 with regard to objections within the rectangular boundary 405 that are in proximity to the target UE 410. For example, the target UE 410 may be able to determine a relative angle with respect to the door 435. Further details will be provided below regarding the signaling that occurs between the target UE 410 and nearby UEs 430e and 430f as part of D2D discovery to determine the coarse location of the target UE 410.

In the fourth example 470, the coarse location of the UE 410 is shown to have a particular defined size area 480 that has been reduced in size as compared to the overall area of the wide beam 442. Once the coarse location has been reduced to area 480, it is possible to use narrow beams within the direction of the reduced area 480 to perform beam acquisition. For example, multiple reference signals, each having a means for being identified, are transmitted on narrow beams of 1 degree each, within the narrow beam range 444 indicated by the dashed lines within the wide beam 442. The target UE can identify which of the 1 degree beams has a best signal strength and feed back that information to the AP 420 and a preferred beam pair between the target UE 410 and AP 420 can be identified.

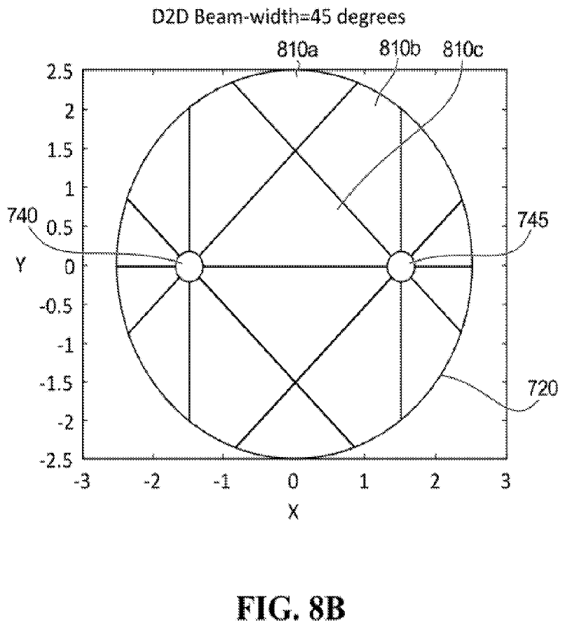

The four examples shown in FIG. 4 appear to show how using all four of the examples together may be helpful in first using a wide beam for determining a coarse location of the UE 110, and then using fixed, or quasi-fixed, UEs to further reduce a size of a coarse location of the UE 110. However, not all of the examples illustrated in FIG. 4 would necessarily be needed or performed in the order that is to be shown from left to right in FIG. 4, when performing beam acquisition. In some embodiments, information that is acquired in one or more of the examples 440, 450, 460, 470 may be determined by the AP 420 at an earlier point in time and stored in memory of the AP 420, and used at a later time as part of beam acquisition. Alternatively, a network that the AP 420 is a part of may provide information to the AP 420 that enables one or more of the examples. In some embodiments, low frequency wide-beam beam sweeping may be performed before beam acquisition is performed and results of the low frequency wide-beam beam sweeping can be stored in memory of the AP for later use, when beam acquisition is performed. In some embodiments, the AP may perform scanning in the area to determine where objects or obstacles in the area proximate to the AP and store that information for later use. In some embodiments, after determining where objects or obstacles in the area proximate to the AP, such location information may be used it to make a low resolution map of the area proximate to the AP for later use, as will be described in detail below with regard to FIGS. 9-12. Several methods can be used to map the direction of the wide beam to area or coarse location that is covered by the wide beam. Such methods include, but are not limited to, fingerprinting techniques, artificial intelligence, and historical data usage or utilization.

Examples 440, 450, 460, and 470 show that the coarse location of the target UE can be determined based on factors such as 1) information about an environment in proximity to the UE comprising a position of at least one object; 2) an identification of nearby UEs with fixed or quasi-fixed locations; 3) D2D discovery comprising beam-sweeping between the UE and nearby UEs with fixed or quasi-fixed locations with wide beam or narrow beam reference signals; or 4) beam-sweeping between the AP and the UE with wide beam low frequency reference signals.

An aspect of attempting to improve beam acquisition efficiency may involve attempting to reduce signaling overhead in the beam sweeping portion of beam acquisition. Because beam sweeping may be performed between a transmitter and a receiver (as a part of wide-beam beam sweeping and narrow-beam sweeping) and between a receiver and other devices in proximity to the receiver (as a part of D2D discovery), the total signaling overhead of the transmitter, receiver and other devices needs to be considered, i.e. the signaling overhead of the beam sweeping between the receiver and nearby devices and the signaling overhead of the beam sweeping the transmitter and the receiver.

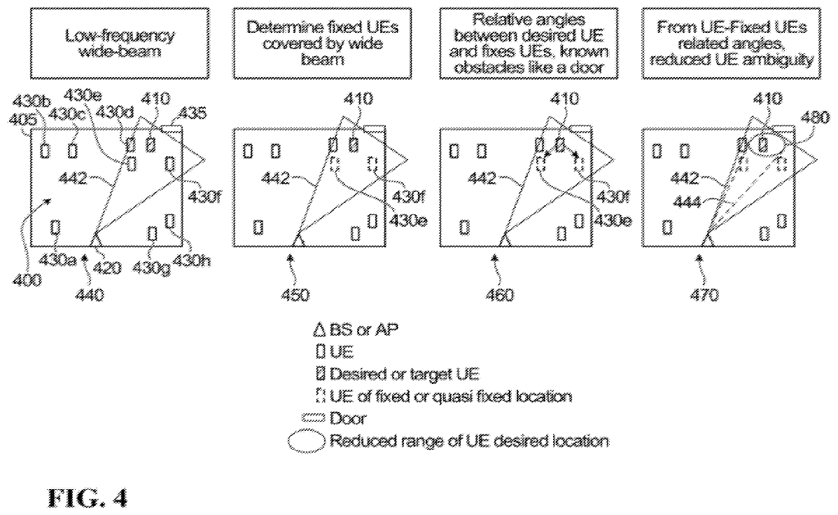

FIG. 5 illustrates an example of a BS 510 attempting to acquire a target UE (UE0 520). While BS 510 is indicated to be the transmitter here, it is to be understood that the BS may be an AP as illustrated in the examples of FIG. 4, or a different BS-type device. UE0 520 is indicated to be approximately 15 meters (m) away from the BS 510. There are two UEs (UE1 535 and UE2 530) that are spaced apart by approximately 4 m and are approximately 4 m away from UE0 510.

The BS 510 estimates a coarse location of UE0 520 by transmitting low frequency reference signal transmissions on wide beams having approximately 30 degrees beamwidth. In order to estimate the coarse location, the BS 510 may transmit several reference signals on wide beams in different directions that cover up to 360 degrees. Only one wide beam 540 is shown in FIG. 5, the wide beam in which UE0 520 is located within. UE0 520 performs measurements of the reference signals transmitted on the wide beams and determines a preferred reference signal, for example, a strongest reference signal. UE0 520 sends feedback to the BS 510 identifying the strongest reference signal on the wide beams. The measurements performed by the UE0 520 may include measuring one or more of received signal received power (RSRP), signal-to-noise ratio (SNR), or received signal strength indicator (RSSI) based on the received reference signals. In some embodiments, the measurements may be compared to a threshold value. If the measurement is equal to or greater than the threshold value it may be considered to have a reference signal strength suitable to feedback to the BS 510. Based on the feedback from UE0 520, the BS 510 can determine the coarse direction of UE0 520 to within a beam width. In this example that would be 30 degrees, but more generally would be comparable to the beam width being used. An example of feedback provided by the UE0 520 may be an index value associated with a respective wide beam that allows the BS 510 to determine which wide beam(s) was received by UE0 520.

If the BS 510 was then to attempt to perform acquisition using high frequency beam sweeping with multiple narrow beams each having 1 degree beam width in conjunction with 1 degree beam width narrow beams at UE0 520 over the entire 30 degree beam width of wide beam 540, the beam sweeping overhead would correspond to 900 beam pairs. The 900 hundred beam pairs are based on 30 1 degree beams at the BS side and 30 1 degree beams at the UE0 520 side for a total of 30×30 possible beam pairs. The use of 1 degree narrow beams and 30 degree wide beams in this example are for the purposes of description and it should be understood that either of the narrow beams or wide beams in practical implementations could be larger or smaller those used in the examples described herein.

However, if the coarse location of a target UE UE0 520 can be further narrowed down to a smaller coarse location area, as proposed by aspects of the present disclosure, then the beam pair overhead may be reduced because a smaller number of narrow beams would be used to cover the narrowed down range of the reduced coarse location area. In a particular example according to FIG. 5, when the BS 510 knows that there are two nearby fixed, or quasi-fixed, UEs (UE1 535 and UE2 530), the BS 510 may instruct UE0 520 to perform device to device (D2D) beam sweeping with the nearby UEs UE1 535 and UE2 530 to determine the coarse location of UE0 510 with greater accuracy. In some embodiments, this may involve determining an angle of departure (AoD) of a reference signal for the nearby UEs 530 and 535 with respect to UE0 520. With regard to FIG. 5, the D2D discovery process may occur between UE0 520 and UE1 530 and between UE0 520 and UE2 535. Upon determining the AoDs, or more generally the information that can be used to determine the location of the UE0 520 with regard to the fixed UEs 530 and 535, the UE0 520 can provide that information to the BS 510. With knowledge of the location of the nearby UEs 530 and 535 and the AoDs with respect to UE0 520 for the nearby UEs 530 and 535, the BS 510 can further narrow down the course location of UE0 510 and therefore further limit the number of narrow beams that may be needed to acquire UE0 520 when performing the narrow-beam beam sweeping. The reduced number of narrow beams being used reduces the overhead based on the number of beam pairs as compared to the number of narrow beams that would be needed to cover the entire 30 degree wide beam.

The D2D discovery process between a target UE and nearby UEs may utilize narrow-beam or wide-beam beam sweeping. Using narrow-beam beam sweeping between the target UE and nearby UEs may result in substantial D2D beam sweeping overhead because many beams are used. Using wide-beam beam sweeping between the target UE and nearby UEs may result in substantial BS-target UE beam sweeping overhead because ambiguity about the target UE location may remain high because the AoD may not be as accurate as when a narrow beam is used. If the AoD is not as accurate, the BS will not be able to narrow down the location of the target UE as much as if narrow beams are used, and therefore the BS 510 may need to use a higher number of narrow beams in the narrow band beam sweeping to acquire the target UE due to the lower accuracy of the coarse location.

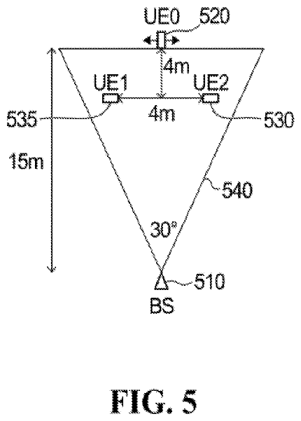

FIG. 6 includes a graphical plot 600 that shows an example of how the beam width used for D2D discovery between the target UE and a nearby UE affects beam sweeping overhead and location accuracy for the example shown in FIG. 5. The horizontal axis of the graphical plot 600 represents the beam width for D2D discovery in degrees ranging from a beam width of 20 to 45 degrees. The left hand vertical axis of the graphical plot 600 represents the beam sweeping overhead in terms of the number of beam pairs ranging from 140 to 300. The right hand vertical axis of the graphical plot 600 represents the location accuracy in meters ranging from 0 to 4 m. The solid line 610 of the graphical plot 600 corresponds to beam sweeping overhead on the left hand vertical axis. The dashed line 620 of the graphical plot 600 corresponds to beam accuracy on the left hand vertical axis. It can be seen that when the beam width is approximately 23 degrees, the location accuracy of the target UE can be determined within approximately 0.25 m, but involves overhead related to approximately 280 beam pairs. It can be seen that when the beam width is approximately 44 degrees, the location accuracy of the target UE can be determined within approximately 3.50 m, and involves overhead related to approximately 280 beam pairs. However, when the beam width is approximately 33 degrees (indicated at oval 630), the location accuracy of the target UE can be determined within approximately 1.25 m and involves overhead related to approximately 155 beam pairs. Therefore, allowing for some location inaccuracy (1.25 m instead of 0.25 m), a wider beam can be used (33 degrees) and a much reduced overhead due to a lower number of beam sweeping pairs being needed.

In addition to the graphical plot 600, FIG. 6 includes beam diagrams 640 and 650 showing the number and directions of beams used by a target UE (located at the center of each of the beam diagrams 640 and 650) that is to perform beam sweeping with nearby UEs. The target UE may need to transmit reference signals in beams covering 360 degrees if it does not know where the nearby UEs are located. If the target UE has some indication of the direction of a nearby UE, the target UE may be able to use fewer beams that cover less than 360 degrees. The first example beam diagram 640 has 16 equal sized beams to cover 360 degrees around the target UE that could be used for D2D communication with other nearby UEs. The second example beam diagram 650 is shown having 8 equal sized beams to cover 360 degrees around the target UE that could be used for D2D communication with other nearby UEs. When narrower beams are used for D2D as shown in the first example beam diagram 640, there is a larger beam pair overhead because there are more beams so there will be more beam pairs, but the end result is higher accuracy for the UE location and a lower beam pair overhead needed for BS to target UE acquisition. When wider beams are used for D2D as shown in the second example beam diagram 650, there is a smaller beam pair overhead, but the end result is lower accuracy for the target UE location and higher beam pair overhead needed for the BS to target UE acquisition.

Embodiments described herein consider beam acquisition between a BS and target UE for downlink communication. However, it should be understood that the described method according to an embodiment (for example as described with regard to FIG. 9) could be applied to uplink and/or side-link communication as well.

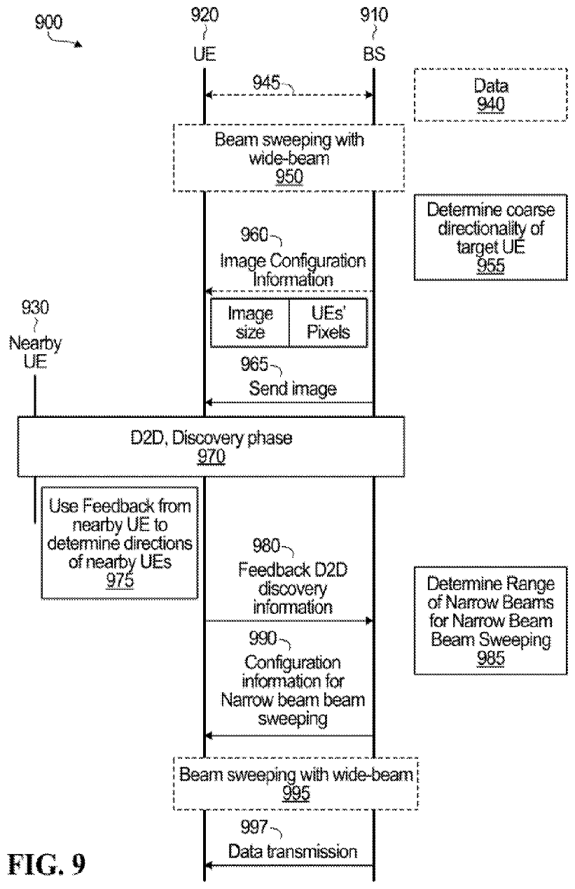

Beam acquisition between the BS and target UE may involve the BS, or the network that the BS is a part of, having knowledge of the area around the BS that the target UE may be located within. The BS, or network, may have information that may include location information of objects and obstacles in proximity of the BS. For example, if the BS is located inside a structure, the BS, or network, may have knowledge of location information regarding doors, windows, pillars, boundary walls and any other objects that may redirect or attenuate a signal transmitted by the BE or the target UE. If the BS is located outside of a structure, the BS, or network, may have knowledge of location information regarding structures, trees, and other geographical objects that may redirect or attenuate a signal transmitted by the BE or the target UE. In some embodiments, this location information may be in the form of a map identifying where objects such as nearby UEs or obstacles in the area are located. The map does not need to have detailed resolution. The map may be as simple as a bitmap that is a matrix of pixels that correspond at some scale to the area, in which one or more pixels that correspond to an object, or obstacle, are “1” and the remainder of the pixels in the map are “0”. The map may identify: an area local to the UE; locations of the one or more nearby UE and an identifier for each of the one or more nearby UE; a location of an object in an area local to the UE; a location of an object to be used as a reference marker in an area local to the UE; and locations of boundaries of sub-areas in an area local to the UE. Examples of such maps are described below with reference to FIGS. 10, 11 and 12.

In some embodiments, the BS may perform wide-beam beam sweeping in an area of the BS using lower frequency reference signals (e.g. sub 6 GHz, lower end of mmWave frequency (28 GHz)) so that the BS can determine a coarse location for the target UE. This could be performed as a part of the beam acquisition method, or it may be performed prior to the beam acquisition method being performed and the information is stored for use during the beam acquisition process.

In some embodiments, the BS, or the network, has information pertaining to the locations of some UEs, such as, but not limited to, sensors or laptops, in the network. Some of the UEs in the network that the BS is aware of may also be identified as having a location that is fixed or quasi-fixed. The UEs may be identified as having a location that is fixed or quasi-fixed based on a location of the devices over long durations of time. As described above, this information may be used to further narrow down the coarse location of the target UE.

In some embodiments, the BS, or network, obtains additional information about the target UE location. Such information may be obtained via one or more of the following described methods.

In some embodiments, the BS, or other devices that are part of the network, may perform sensing to determine information such as the existence of objects, and their position, in proximity of the area of the BS. If the BS is located inside a structure, the BS, or other devices that are part of the network, may determine location information by sensing pertaining to doors, windows, pillars, boundary walls and any other objects that may redirect or attenuate a signal. If the BS is located outside of a structure, the BS, or other devices that are part of the network, may determine location information by sensing pertaining to structures, trees, and other geographical objects that may redirect or attenuate a signal. In some embodiments, the BS may be provided with location information by the network and the BS can store the information for use when performing beam acquisition as described in embodiments of the present disclosure.

In some embodiments, the BS may perform out-of-band beam sweeping in which wide-beam beam sweeping between the BS and the UE is carried out at lower frequency (e.g. sub 6 GHz and lower end of mmWave frequency such as around 28 GHz). As described above, the BS may transmit reference signals on wide-beams in multiple directions and receive feedback from the target UE that enables the BS, or network, to determine a coarse location of the target UE, to within the range of the beam width of one or more wide angle beam.

In some embodiments, relative angles and/or distances may be determined between the target UE and nearby UEs that have locations known to the BS. In some embodiments, the term “relative angles” means that the angles are with respect to a specific direction, e.g. with respect to north, with respect to a direction of a known fixed UE, or with respect to a direction to a known object. For example, the UE may have a gyroscope that allows the UE to determine the beam orientation with respect to the north direction.

The BS, or the network, using the previously acquired information and/or additional information that may aid in determining the coarse location of the target UE, proceeds to determine the coarse location of the target UE and then the BS and target UE can perform narrow-beam beam sweeping in a higher frequency range (i.e. subTHz frequency) to acquire one or more beams that can subsequently be used to communicate data and control information.

In some embodiments, D2D discovery may be used to determine relative angles between the target UE and the nearby UEs. Specifically, the target UE and nearby UEs may perform beam sweeping such that the target UE determines the direction (e.g. AoD) to other nearby UEs. As explained with regard to the first example beam diagram 640 in FIG. 6, when narrow beams are used for D2D, there is a larger beam pair overhead as compared to using wide beams, but the end result is higher accuracy for the target UE location and lower beam pair overhead as part of the BS to target UE beam acquisition. With regard to the second example beam diagram 650 in FIG. 6, when wide beams are used for D2D, there is a smaller beam pair overhead as compared to using narrow beams, but the end result is lower accuracy for the UE location and higher beam pair overhead as part of the BS to target UE beam acquisition. Therefore, the beam-width for D2D discovery may be selected to balance the reduction of the beam pair overhead with accuracy of the coarse location of the target UE.

An area indicated to be a coarse location area of the target UE may depend on one or more of the following: an orientation and beam-width of the beams used by the target UE, an orientation and beam-width of the beams of the nearby UEs, and obstacles in the area that may be information from the BS, or network, or information that has been acquired by the target UE.

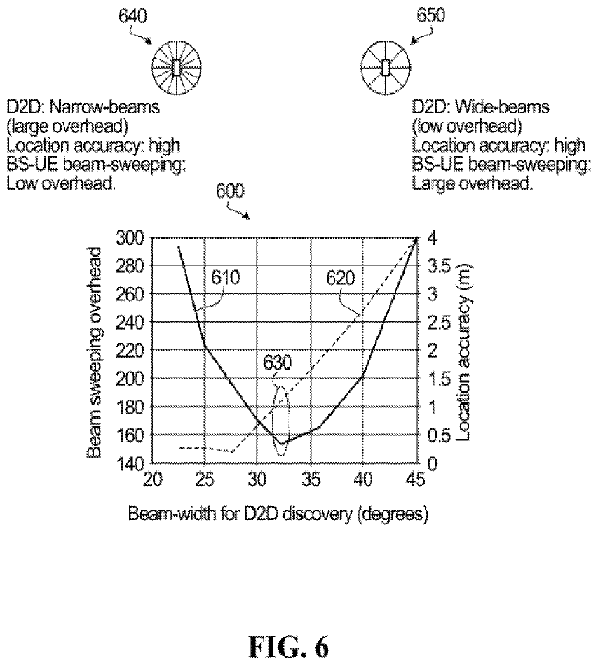

FIG. 7 is another example in which a BS 730 is attempting to acquire a target UE 705. The location of the target UE 705 is not known exactly by the BS 730 within a coarse location area 720. The BS 730 performs wide-beam beam sweeping between the BS 730 and the target UE 705 using lower frequency reference signals and determines a coarse location of the target UE 705 based on a wide beam 710 being indicated to have a strongest signal strength by the target UE 705. The BS, network, or target UE in FIG. 5 determines a circular area of approximately 5 meters diameter that includes the target UE 705, which is based on the angle of the wide beam 710 and an approximate distance to the target UE 705. The BS 730, or network, determines that the coarse location area 720 includes two UEs (UE1 740 and UE2 745) that are known to be fixed location UEs and that are approximately 3 meters apart. The BS 730, or network, instructs the target UE 705 to perform D2D discovery with UE1 740 and UE2 745.

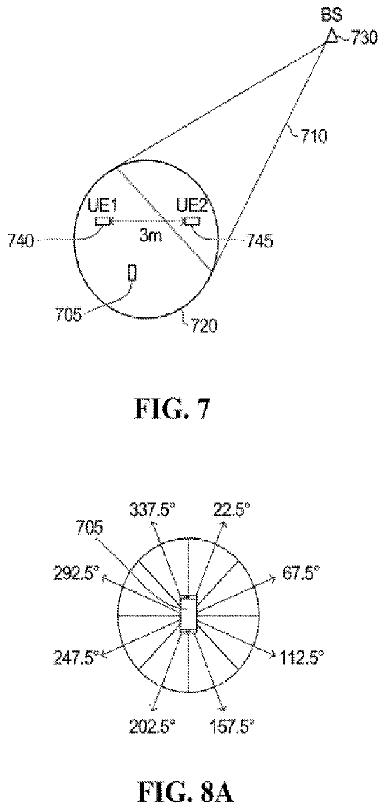

The target UE 705 performs beam sweeping via 8 beams of 45 degrees width (for full 360 degree coverage around the target UE 705) to find the nearby UE1 740 and the nearby UE2 745. FIG. 8A includes a beam diagram that illustrates an orientation of directions of 8 beams at 22.5, 67.5, 112.5, 157.5, 202.5, 247.5, 292.5, and 337.5 degrees around a target UE 705.

FIG. 8B illustrates an example of potential sub-areas 810 (three of which are identified as 810a, 810b and 810c) of where the target UE 705 may be located within the coarse location area 720 based on the fact that there are two nearby UEs and 8 wide beams being used by the target UE 705 for D2D discovery.

The number of potential sub-areas 81o and the shape of the sub-areas depend on the number of nearby UEs and the number of beams, the width of the beams and the orientation of beams being used by the target UE 705 and the nearby UEs 740 and 745. Other factors that may affect the shape of the sub-areas include the quality of the measurements being made during the D2D process and assisting measurements made by the BS. The areas can be determined via the beams of the target UE, nearby UEs, or both target and all or some nearby UEs.

Based on the example shown in FIG. 7, there are 16 sub-areas 81o in the coarse location area 720 where the target UE 705 may be located, as shown in FIG. 8B. The target UE 705 is using 8 wide beams for the D2D discovery with the 2 nearby UEs UE1 740 and UE2 745. The target UE 705 obtains feedback information from each nearby UE 740 and 745, which can be used in identifying 1 of 8 different directions (corresponding to each of the 8 wide beams) for each the nearby UEs. The feedback information may be an index of a wide beam signal that has a strongest measured reference signal or that exceeds a measure reference signal threshold. The feedback information may enable the target UE to determine an AoD from the target UE to the respective nearby UE. Each sub-area 810 represents a possible location within the coarse location area 720 of the target UE 705, based on one of the eight beam directions being the direction for UE1 740 and one of the eight beam directions being the direction for UE2 745. For example, in sub-area 810c, the AoD1 from the target UE 705 to UE1 740 is 202.5 degrees and the AoD2 from the target UE 705 to UE2 745 is −22.5 degrees. Geometrically, the target UE 705 can only be found within the boundaries of the sub-area 810c. Each sub-area 810 is geometrically defined based on the directionality of the one or more nearby UEs with respect to the target UE 705.

FIG. 8B is an example coarse location area having a particular number, size and shape of sub-areas 810. The number, size and shape of sub-areas in a coarse location area may depend on one or more of the following:
the orientation of the beams on which the reference signals are transmitted, e.g. if beam directions are rotated, for example if the beams were arranged as {0, 45, 90, 135, 180, 225, 270, 315} degree instead of {22.5, 67.5, 112.5, 157.5, 202.5, 247.5, 292.5, and 337.5} degrees as shown in FIG. 8A;
the beam-width of the beams, which affects the total number of beams; or
whether obstacles exist between the target UE and the nearby UEs.

Once the target UE 705 informs the BS 730 regarding the directionality of the nearby UEs UE1 740 and UE2 745 with respect to the target UE 705 (for example in the form of AoDs or a functions of AoD), the BS 730, or the network that the BS 730 is a part of, can determine that the UE is within sub-area 810c within the overall coarse location area 720. An example of a “function of the AoD” may be an indication of the sub-area in the form of an image or a map, an identification of a sub-area index from amongst the possible 16 sub-areas, an indication of a difference in the directionality (e.g. difference in AoD) from the target UE 705 and UE1 740 and the target UE 705 and UE2 745, or other information that can allow the BS, or network to further narrow the coarse location of the target UE 705.

The BS 730 and the target UE 705 can then perform narrow-beam beam sweeping at higher frequencies with one or more beams that collectively cover sub-area 810c that has been determined to likely include the target UE 705. Moreover, the BS may reduce the selected sub-area before performing narrow beam sweeping with the target UE. Hence, the BS, or network, may again instruct the target UE and nearby UEs to perform further measurements via narrower beams in order to determine a smaller area within the selected sub-area.

FIG. 9 is an example of a signaling flow diagram 900 for a beam acquisition method according to embodiments of the disclosure. The signaling flow diagram 900 includes signaling between a BS 910, a target UE 920 and a nearby UE 930. While only a single nearby UE 930 is shown in the signaling flow diagram 900, it is to be understood that D2D discovery may occur between the target UE 920 and multiple nearby UEs. The signaling flow diagram 900 generally describes a method that includes determining course location information regarding a location of the target UE 920 and performing beam-sweeping for beam acquisition between the target UE 920 and the BS 910 using one or more narrow beam high frequency reference signal, wherein the beam-sweeping overhead is dependent upon the determined coarse location information. As discussed above with regard to FIG. 4, and described with regard to FIG. 9, there are several ways that the course location information regarding the location of the target UE 920 may be determined.

In some embodiments, data 940 is stored at the BS 910, or the network that the BS 910 is a part of and the information can be provided to the BS 910. The data 940 may be information such as location information of objects and obstacles in proximity of the BS 910. For example, if the BS 910 is located indoors, the data 940 may include location information of doors, windows, pillars, boundary walls and any other objects that may redirect or attenuate a signal. If the BS 910 is located outdoors, the data 940 may include location information of structures, trees, and other geographical objects that may redirect or attenuate a signal. In some embodiments, this location information may be in the form of a low resolution map (e.g., a bitmap that is matrix of pixels corresponding to the area) identifying where the objects are located. In some embodiments, as opposed to all of the data 940 being previously obtained and stored at the network and/or the BS 910, some or all of the data 940 may be gathered by the BS 910 and/or the network during the beam acquisition method, for example as part of sensing step 945. Sensing step 945 involves the BS 910, and/or other devices in the network (not shown) or other sensing agents (not shown), optionally performing sensing to determine further information about the area local to the BS 910, such as the location of objects or obstacles in the area. In some embodiments, a sensing agent can be a sensing node that is part of the network and is only used for sensing, not communication with other nodes. In some embodiments, a sensing agent may perform sensing using non-cellular radio frequency techniques such radar, a camera, or GPS. In some embodiments, information that may be obtained by sensing is added to the data 940 stored at the BS 910 or network.

At step 950, beam sweeping is carried between the BS 910 and target UE 920 by performing beam sweeping with wide beams. Performing wide-beam beam sweeping involves the BS 910 sending reference signals that can be individually identified by the target UE in different directions (i.e. 360 degrees around the BS 910). The beam sweeping may use low-frequency signaling, e.g., wide beam out-of-band reference signal. An example of a type of reference signal that may be sent by the BS 910 is a channel state information reference signal (CSI-RS). Another type of reference signal that may be sent by the BS 910 is a positioning RS (PRS). While these two types of RS are identified as examples, other types of RS could also be used. The type of reference signal selected by the BS 910 may be indicated to the target UE 920 in the form of configuration information transmitted via radio resource control (RRC) signaling or other types of DL channel signals, such as downlink control information (DCI) or media access control-control element (MAC-CE). The configuration information may also include one or more of time/frequency resource information, RS modulating sequence information, quasi-co-location (QCL) information and periodicity information pertaining to the reference signal being transmitted. In some embodiments, the reference signals each have an index that is associated with a particular directionality of a reference signal beam. The indices associated with the reference signals may be provided to the target UE 920 as part of the RRC or DL channel signal configuration information.

In some embodiments, as part of performing the beam sweeping 950, the target UE 920 may receive the reference signals, perform measurements and determine one or more of received signal received power (RSRP), signal-to-noise ratio (SNR), received signal strength indicator (RSSI) based on the received reference signals.

In some embodiments, as part of performing the wide-beam beam sweeping 950, the target UE 920 transmits feedback information to the BS 910 and/or to the network that can be used by the BS 910 and/or network to determine a coarse location of the target UE 920. In some embodiments, the target UE 920 may feedback an index of one or more reference signals with a measurement that meets and/or exceeds a specific threshold of the measurement. For example, when the SNR is equal to or greater than a specific value that is indicative of a good communication signal strength between the BS 910 and target UE 920.

The BS, or network, may perform processing 955 to determine the coarse location of the target UE 920 based on the feedback information received during the beam sweeping 950. This may be similar to the finding the coarse location of the UE based on wide beam 442 in the example 440 of FIG. 4 or the wide beam 540 in FIG. 5.

In some embodiments, determining the coarse location of the target UE 920 using the feedback information from the beam sweeping 950 and/or data 940, may involve the BS 910 determining one or more areas covered by a respective beam. FIG. 10 shows an example of two areas 1040 and 1050 resulting from a transmitted wide beam 1060. FIG. 10 is similar to the bounded room examples shown in FIG. 4. An AP 1010 is attempting to acquire a target UE 1020 within the bounded room 1015 and there are several addition UEs in the area. The wide beam 1060 transmitted by the AP 1010 is shown to include two areas 1040 and 1050. The first area 1040 includes two UEs 1030b and 1030c. Because the wide beam 1060 is reflected by the boundary wall, a second area resulting from the reflected beam is also identified. The second area 1050 includes the target UE 1020 and two nearby UEs 1030d and 1030e. In some embodiments, there may be a benefit of identifying two smaller areas, such as Area 11040 and Area 2 1050, instead of a single large area covering both smaller areas as there may be lower beam pair overhead associated with using the two smaller areas. For example, if a map type image is generated by the AP 1010 and transmitted to the target UE 1020 for an area where the area is represent by a 100 pixel by 100 pixel map type image, as opposed to two small 10 pixel by 10 pixel areas, the overhead associated with transmitting the two smaller images is considerably less than the overhead associated with transmitting the single larger image, especially if the images are transmitted to the target UE 1020, updated and then sent back to the AP 1010.

In some embodiments, the processing 955 may include using the feedback information from the beam sweeping 950 and/or data 940, for the BS 910 to determine that one or more nearby UEs are within one or more areas covered by the beam, such as UEs 1030b and 1030c in the first area 1040 and UEs 1030d and 1030e in the second area 1050 as shown in FIG. 10.

In some embodiments, the processing 955 may include using the feedback information from the beam sweeping 950 and/or data 940, for the BS 910 to determine one or more obstacles exist in the one or more areas. While not shown in FIG. 10, objects such as doors, windows, or other structures could be included in the one or more areas.

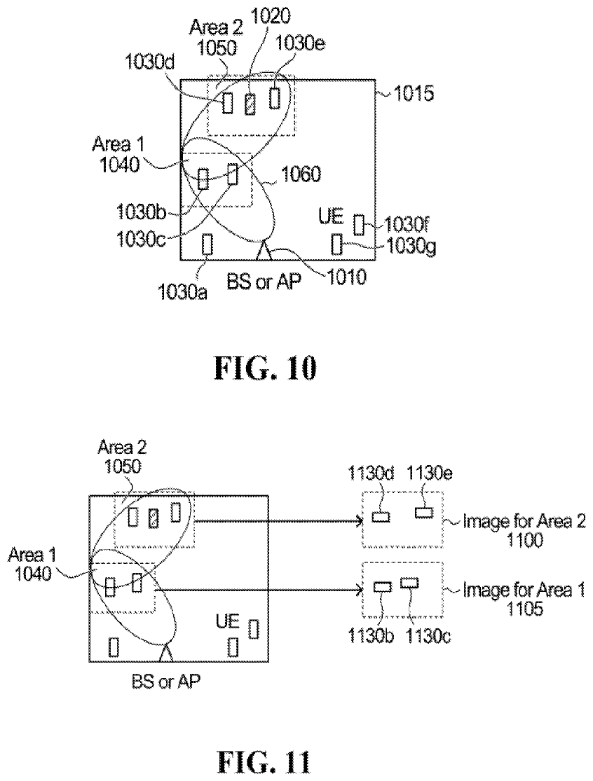

In some embodiments, the processing 955 may include the BS 910, or the network, generating one or more map type images that represent the one or more areas as shown in the example of FIG. 11. FIG. 11 shows two map type images 1100 and 1105 that each have a discrete number of pixels intended to represent the first area 1040 and the second area 1050, respectively, as shown in FIG. 10. Particular pixels 1130b and 1130c within map type image 1100 are representative of UE 1030b and 1030c. Particular pixels 1130d and 1130e within map type image 1105 are representative of UE 1030d and 1030e.

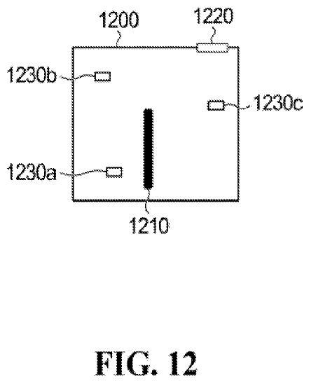

In some embodiments, the processing 955 may include the BS 910, or network, generating one or more small size images (i.e. maps) that include the nearby UEs, objects, and obstacles, which are represented by respective pixels as shown in FIG. 12. FIG. 12 shows a map type image 1200 that is a discrete number of pixels in size intended to represent an area served by an AP. Particular pixels within the map type image are indicated to represent objects in the area, including an obstacle 1210 to beam transmission, a door 1220 and three UEs 1230a, 1230b and 1230c.

In some embodiments, the map type image may be a bit-map image in which locations of UEs, objects and obstacles are denoted by “1” and the remainder of the pixels in the bit-map are “0”.

In some embodiments in which the BS 910 and the target UE 920 use image information as part of the method described in FIG. 9, the BS 910, or network, may send high layer configuration information via downlink (DL) channel signaling to inform the target UE 920 about the structure of the map type image, for example as indicated at optional step 960. The configuration information may include one or more of: an identification of the image size; an identification of pixels that show existence of the one or more nearby UEs; public IDs of the one or more nearby UEs; an identification of pixels that show existence of nearby obstacles; or an identification of pixels that show boundaries of the sub-areas that may be used to indicate the coarse location of the target UE.

In some embodiments, when the BS 910 and the target UE 920 use map type image information as part of the method described in FIG. 9, the BS, or network, may send the map type images generated by the BS 910, or the network, to the target UE 920, as shown at optional step 965. The BS 910 sending map type image information to the target UE 920 enables the target UE 920 to receive an identification of one or more nearby UE with which to perform D2D discovery. The map type images may identify: an area local to the UE; locations of the one or more nearby UE and an identifier for each of the one or more nearby UE; a location of an object in an area local to the UE; a location of an object to be used as a reference marker in an area local to the UE; and locations of boundaries of sub-areas in an area local to the UE. The target UE 920 may use this image information to determine possible directionality of the nearby UE 930, which could reduce the beamforming overhead involved with D2D discovery. The target UE 920 may use the image information provided by the BS 910, or the network, when providing feedback to the BS 910, or network, as will be described below with regard to step 980 of FIG. 9.

The target UE 920 and nearby UE 930 perform D2D discovery 970. In some embodiments, the BS 910, or network, may activate the D2D discovery 970 between the target UE 920 and the nearby UE 930. The activation by the BS 910 may involve the BS 910 configuring the type of reference signals to be exchanged between the target UE 920 and the nearby UE 930 via RRC signaling configuration or other type of DL channel signals. In some embodiments, the BS 910, or the network, transmits configuration information to the target UE 920 such as a type of reference signal that may be sent by the target UE 920. The configuration information may also include for each reference signal to be transmitted by the target UE 920 to the nearby UEs, an identification of a particular direction the reference signal will be transmitted toward for a given nearby UE and a beamwidth for the reference signal. The target UE 920 may then transmit configuration information including the type of reference signal being used in the D2D discovery to the nearby UEs. An example of a type of reference signal may include a sounding reference signal (SRS). The configuration information may also include one or more of time/frequency resource information, RS modulating sequence information, QCL information and periodicity information pertaining to the reference signal being transmitted.

In some embodiments, as part of the D2D discovery 970, the target UE 920 sends a reference signal on beams in each of multiple different directions to be detected by the nearby UE 930. The orientation (i.e. the directionality of the respective beams) and beam-widths used by the target UE 920 may be provided as configuration information by the BS 910. In some embodiments, the target UE 290 may use information from the BS 910, or the network, to balance reducing the number of beams and the accuracy of the coarse location of the target UE to consequently reduce the number of beam pairs involved in the D2D discovery 970.

As part of the D2D discovery 970, the nearby UE 930 performs beam sweeping and making measurements (e.g. one or more of RSRP, SNR, RSSI, etc.) of the reference signals transmitted by the target UE 920.

In some embodiments, as part of the D2D discovery 970, the nearby UE 930 transmits feedback information to the target UE 920 that enables the target UE 920 to determine 975 the directionality of the nearby UE 930. In some embodiments, the feedback information transmitted by the nearby UE 930 may be an index of one or more reference signals (corresponding to one of the beams) that has a measurement that is equal to or greater than a threshold value (e.g., SNR is greater or equal a specific value).

The target UE 920, when provided with the feedback information from the nearby UE 930, may determine 975 one or more of the following:
one or more AoD from the target UE 920 in the direction of the nearby UE 930;
one or more angle of arrival (AoA) at the nearby UE 930 from the direction of the target UE 920;
a location of the UE with reference to at least one of the one or more nearby UE, obstacles and objects to be used as a reference marker in an area local to a UE;
one or more pixel address that would be associated with the location of the target UE 920 on an image map that is provided by the BS 910 at step 965;
one or more sub-areas inside the coarse location area as described with regard to FIG. 8B; or
one or more images, (such as a bitmap) based on an image that may have been received from the BS 910 at step 965, the one or more images including a course location area identifying where the target UE 910 may be located that includes the objects in the area local to the UE and a location of the UE.

Some embodiments of performing the D2D discovery may corresponds to example 460 in FIG. 4 or the example of FIG. 7.

The target UE 920 then transmits 980 the feedback information pertaining to the D2D discovery 970, for example that may have been determined at step 975 to the BS 910.

In some embodiments, the nearby UE 930 can send (not shown) feedback information to the BS 910, or the network, that enables the BS 910 to determine the directionality of the nearby UE 930 with respect to the target BS 920 and therefore determine the location of the target UE with better accuracy.

In some embodiments, the BS 910, or the network, once having received feedback information from the target UE 920, determines 985 an angular range of narrow beams for narrow-beam beam sweeping to be used for acquisition between the BS 910 and the target UE 920.

In some embodiments, the BS 910, or the network, transmits 990 configuration information to the target UE 920 such as a type of reference signal that may be sent by the BS 910. An example of a type of reference signal may include a CSI-RS. The configuration information may also include one or more of time/frequency resource information, RS modulating sequence information, QCL information and periodicity information pertaining to the reference signal being transmitted. The configuration information may be transmitted via RRC signaling or other types of DL channel signals, such as DCI or MAC-CE.

Similar to the procedure used at lower frequency with wide beams, beam sweeping is performed 995 using the narrow beams with the angular range of beam sweeping determined at step 985. In some embodiments, the reference signals transmitted by the BS 910 each have an index that is associated with a particular directionality of a reference signal beam. The indices associated with the reference signals may be provided to the target UE 920 as part of the RRC or DL channel signal configuration information.

As part of performing the narrow-beam beam sweeping 985, the target UE 920 may receive the reference signals and perform measurements and determine one or more of RSRP, SNR, or RSSI based on the received reference signals.

Based on the measurements made by the target UE 920, the target UE 920 transmits feedback information to the BS 910 and the BS 910, or the network, determines an appropriate one or more beam pair for data transmission between the BS 910 and the target UE.

Data transmission 997 can be carried out between the BS 910 and target UE 920 using the selected one or more beam pair.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
determining location information regarding a location of a user equipment (UE); and
performing beam-sweeping for beam acquisition between the UE and a base station (BS) using one or more reference signals in a beam determined in accordance with the location information.

2. The method of claim 1, wherein the determining the location information regarding the location of the UE comprises determining the location information using one or more of:
information about an environment in proximity to the UE, the information indicating a position of at least one object in the environment;
identification information of nearby UEs with fixed or quasi-fixed locations;
device-to-device (D2D) discovery comprising first beam-sweeping between the UE and the nearby UEs with the fixed or quasi-fixed locations with wide beam reference signals or narrow beam reference signals; or
second beam-sweeping between the BS and the UE with reference signals sent in a wide beam at a low frequency.

3. The method of claim 2, wherein the method is applied at UE side, the D2D discovery between the UE and the nearby UEs with the fixed or quasi-fixed locations comprises:
selecting one or more nearby UEs with which to perform the D2D discovery; or
receiving one or more identifications of the one or more nearby UEs with which to perform the D2D discovery.

4. The method of claim 1, wherein the method is applied at UE side, the performing the beam-sweeping between the UE and the BS comprises:
receiving the one or more reference signals that have been sent in a direction based on the location information regarding the location of the UE;
measuring the one or more reference signals; and
transmitting first feedback information resulting from measurement of the one or more reference signals.

5. The method of claim 2, wherein the method is applied at UE side, the method further comprising:
receiving an indication that the UE is to perform the D2D discovery with one or more nearby UEs.

6. The method of claim 1, wherein the location information regarding the location of the UE further comprises one or more of:
a size of an area local to the UE;
identifications of locations of one or more nearby UEs and a corresponding identifier for each of the one or more nearby UEs;
an identification of a location of an object in the area local to the UE;
an identification of a location of an object to be used as a reference marker in the area local to the UE; or
identifications of locations of boundaries of sub-areas in the area local to the UE.

7. The method of claim 2, wherein the method is applied at UE side, and the performing the second beam-sweeping between the BS and the UE with the reference signals sent in the wide beam at the low frequency comprises:
receiving one or more wide beam out-of-band reference signals;
measuring the one or more wide beam out-of-band reference signals; and
transmitting an identification of a wide beam out-of-band reference signal determined to have a measured signal strength equal to or larger than a threshold.

8. The method of claim 1, wherein the method is applied at UE side, the method further comprising:
receiving configuration information identifying one or more angles of arrival (AoAs) relative to a particular direction for receiving the one or more reference signals.

9. The method of claim 1, wherein the method is applied at BS side, and the performing the beam-sweeping between the UE and the BS comprises:
transmitting the one or more reference signals in a direction based on the location information regarding the location of the UE;
receiving first feedback information resulted from measurement of the one or more reference signals; and
determining one or more angles of departure (AoDs) at the BS and one or more AoAs at the UE based on the first feedback information.

10. The method of claim 9, further comprising:
transmitting one or more identifications of one or more nearby UEs nearby to the UE with which to perform D2D discovery.

11. A device comprising:
at least one processor; and
a computer-readable medium having stored thereon processor executable instructions that, when executed by the at least one processor, cause the device to perform operations including:
determining location information regarding a location of a user equipment (UE); and
performing beam-sweeping for beam acquisition between the UE and a base station (BS) using one or more reference signals in a beam determined in accordance with the location information.

12. The device of claim 11, wherein the determining the location information regarding the location of the UE comprises determining the location information using one or more of:
information about an environment in proximity to the UE, the information indicating a position of at least one object;
identification information of nearby UEs with fixed or quasi-fixed locations;
device-to-device (D2D) discovery comprising first beam-sweeping between the UE and the nearby UEs with the fixed or quasi-fixed locations with wide beam reference signals or narrow beam reference signals; or
second beam-sweeping between the BS and the UE with reference signals sent in a wide beam at a low frequency.

13. The device of claim 12, wherein the device is applied at UE side, the D2D discovery between the UE and the nearby UEs with the fixed or quasi-fixed locations comprises:
selecting one or more nearby UEs with which to perform the D2D discovery; or
receiving one or more identifications of the one or more nearby UEs with which to perform the D2D discovery.

14. The device of claim 11, wherein the device is applied at UE side, the performing the beam-sweeping between the UE and the BS comprises:
receiving the one or more reference signals that have been sent in a direction based on the location information regarding the location of the UE;
measuring the one or more reference signals; and
transmitting first feedback information resulting from measurement of the one or more reference signals.

15. The device of claim 12, wherein the device is applied at UE side, the operations further comprising:
receiving an indication that the UE is to perform the D2D discovery with the one or more nearby UEs.

16. The device of claim 11, wherein the location information regarding the location of the UE further comprises one or more of:
a size of an area local to the UE;
identifications of locations of one or more nearby UEs and a corresponding identifier for each of the one or more nearby UEs;
an identification of a location of an object in the area local to the UE;
an identification of a location of an object to be used as a reference marker in the area local to the UE; or
identifications of locations of boundaries of sub-areas in the area local to the UE.

17. The device of claim 12, wherein the device is applied at UE side, and the performing the second beam-sweeping between the BS and the UE with the reference signals sent in the wide beam at the low frequency comprises:
receiving one or more wide beam out-of-band reference signals;
measuring the one or more wide beam out-of-band reference signals; and
transmitting an identification of a wide beam out-of-band reference signal determined to have a measured signal strength equal to or larger than a threshold.

18. The device of claim 11, wherein the device is applied at UE side, the operations further comprising:
receiving configuration information identifying one or more angles of arrival (AoAs) relative to a particular direction for receiving the one or more reference signals.

19. The device of claim 11, wherein the device is applied at BS side, and the performing the beam-sweeping between the UE and the BS comprises:
transmitting the one or more reference signals in a direction based on the location information regarding the location of the UE;
receiving first feedback information resulted from measurement of the one or more reference signals; and
determining one or more angles of departure (AoDs) at the BS and one or more AoAs at the UE based on the first feedback information.

20. The device of claim 19, the operations further comprising:
transmitting one or more identifications of one or more nearby UEs nearby to the UE with which to perform D2D discovery.
